(19) United States
(12) Patent Application Publication
(10) Pub. No.: US 2013/0103770 A1
(43) Pub. Date: Apr. 25, 2013

(54) DISTRIBUTED SEMI-SYNCHRONIZED EVENT DRIVEN PLAYBACK OF MULTIMEDIA

(71) Applicants: Kimberly Kamolz, Kirkland, WA (US); Peter Eberhardy, Seattle, WA (US); Daniel Cheung, Mountain View, CA (US); Hong Lin, Bellevue, WA (US); James Yamat, Redwood City, CA (US); Gideon Goodwin, Mountain View, CA (US); Kwok Fai Chan, Burnaby (CA)

(72) Inventors: Kimberly Kamolz, Kirkland, WA (US); Peter Eberhardy, Seattle, WA (US); Daniel Cheung, Mountain View, CA (US); Hong Lin, Bellevue, WA (US); James Yamat, Redwood City, CA (US); Gideon Goodwin, Mountain View, CA (US); Kwok Fai Chan, Burnaby (CA)

(73) Assignee: Microsoft Corporation, Redmond, WA (US)

(21) Appl. No.: 13/280,652

(22) Filed: Oct. 25, 2011

(51) Int. Cl. G06F 15/16

(52) U.S. Cl. 709/206; 709/204

(57) ABSTRACT

A system is provided for enabling attendees of an online broadcast within a collaborative environment to interact with multimedia content during the online broadcast. By rendering the content itself instead of images derived from the content that cannot be interacted with, attendees are enabled to either drive their own multimedia experience, including play, seek, pause/stop, or follow the presenter and consume the multimedia based on the presenter's action (play, pause, stop, seek). The multimedia content may be rendered on each attendee's individual client device through local caching, which contributes to playback quality such that each individual attendee may be able to interact with and control the playback experience of the multimedia content independently.

### BACKGROUND

Sharing multimedia content during an online meeting or broadcast is a common occurrence in a collaborative environment. Typically, a presenter may initiate an online meeting with one or more other users, and the presenter may provide multimedia content, which the presenter may desire to share with one or more attendees of the online meeting. An online meeting may include any environment in which multiple users may collaborate and have viewing access to shared documents or files, such as whiteboard sharing, desktop sharing, and application sharing environments.

In a typical collaborative environment for sharing multimedia content, the presenter may share the multimedia content on the presenter's device and may present and discuss the multimedia content to the attendees of the online meeting. Multimedia content can include audiovisual files, slideshow presentations and other similar content. Typically, the attendees of the online meeting may be able to view the shared multimedia content provided by the presenter, and the attendees may follow along with the presenter's playback of the multimedia content. However, the attendees may not be able to interact with the multimedia content while the presenter presents it, and the attendees may not be able to exercise control over the content to manage and drive the attendee's individual playback experience of the multimedia content. Also, the presenter may not be able to drive the attendee's playback experience.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a system for enabling attendees of an online broadcast within a collaborative environment to interact with multimedia content during the online broadcast. By rendering the content itself instead of images derived from the content that cannot be interacted with, attendees are enabled to either drive their own multimedia experience, including play, seek, pause/stop, or follow the presenter and consume the multimedia based on the presenter's action (play, pause, stop, seek, scan, etc.). The multimedia content may be rendered on each attendee's individual client device through local caching, which contributes to playback quality such that each individual attendee may be able to interact with and control the playback experience of the multimedia content independently.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a system for enabling interaction with multimedia content in a collaborative environment according to embodiments;

FIG. 2 illustrates an example system for enabling independent control over multimedia content by attendees in a collaborative environment;

FIG. 3 illustrates an example scenario for enabling independent control over multimedia content by attendees in a collaborative environment according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for process 600 for enabling independent playback control over multimedia content in a collaborative environment according to embodiments.

### DETAILED DESCRIPTION

As briefly described above, a system is provided for enabling attendees of an online broadcast within a collaborative environment to interact with multimedia content and to independently drive the playback experience of the multimedia content on the attendee's own client device. The system may additionally enable a presenter to drive the multimedia content playback experience such that the attendees may view the multimedia content as the presenter controls the playback actions. The system may render the multimedia content on each attendee's individual client device such that each individual attendee may be able to interact with and control the playback experience of the multimedia content on the attendee's own client device. The attendee may perform play, pause, seek, scan, stop and other similar playback actions on the multimedia content in order to view the content at the attendee's own desire and pace. Further actions by an attendee may include, but are not limited to, taking notes (or ink) on top of the multimedia, or save the multimedia for later viewing. When each individual attendee interacts with the multimedia content rendered on his own client device and exercises playback control over the multimedia content, the presenter's playback and the attendee's playback may be un-synchronized, such that the presenter's playback of the multimedia content may not be broadcast to the attendee's client device and the attendee may not view the presenter's playback of the multimedia content. In another example implementation a feature like picture-in-picture may be provided such that the attendee can see the presenters view as well as the independent navigation. The presenter's client device may continuously provide playback state information of the multimedia content to the server system may enable the attendee to re-synchronize with the presenter's multimedia content playback if and when the attendee desires.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents. While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for enabling interaction with multimedia content shared over a collaborative environment. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

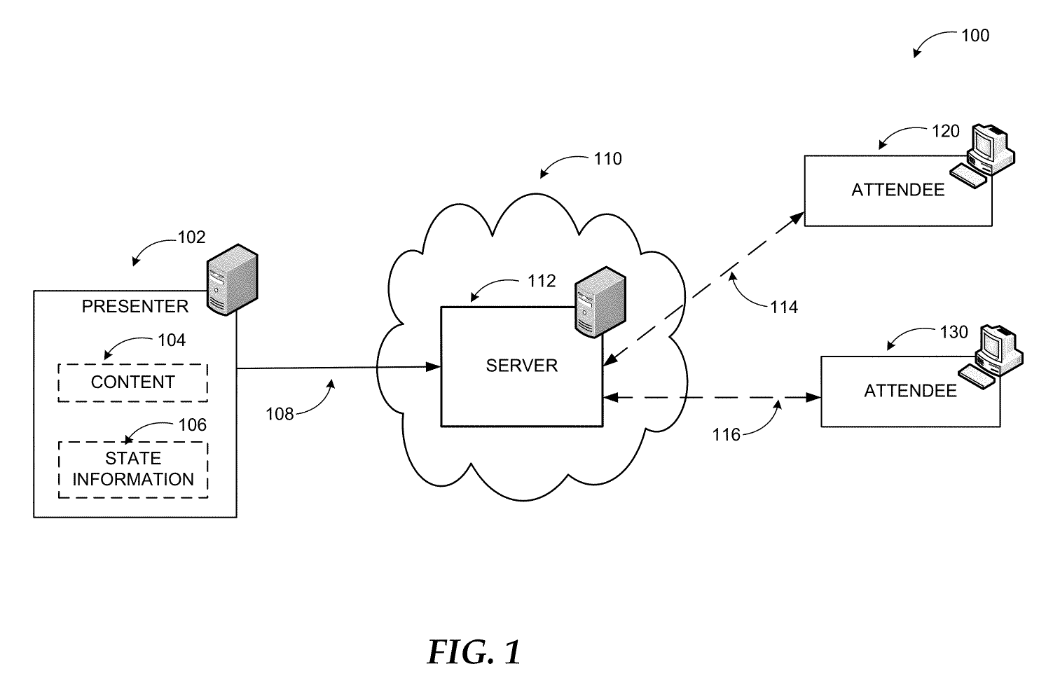

FIG. 1 illustrates a system for enabling interaction with multimedia content in a collaborative environment according to embodiments. As illustrated in diagram 100, in a collaborative environment such as a networked environment 110, a presenter 102 and one or more attendees 120, 130 may interact with each other and share content over a server 112. According some embodiments, more than one presenter may share content. According to other embodiments, communication may also include from an attendee to a presenter. For example, the presenter might need to know how many attendees have gone out of sync with their presentation. In an example scenario, the presenter 102 may generate or select from existing multimedia content 104 for sharing and presenting to one or more attendees 120, 130 during an online meeting hosted by the server 112 within the networked environment 110. In the networked environment 110, the multimedia content may be shared and exchanged using a variety of sharing methods, such as for example, e-mail messaging, text messaging, conferencing, whiteboard sharing, desktop sharing, and application sharing. The multimedia content 104 may be any content that may be shared over the networked environment such as audio files, video files, image files, word processing files, spreadsheet files, presentation files, and other similar files that may contain multimedia content, as well as stream video/audio, which support the some basic playback such as play/pause (or even seek).

The presenter 102 may upload the multimedia content 104 to the server 112, and the server 112 may share or broadcast the multimedia content 104 such that the one or more attendees 120, 130 may be able to view the multimedia content 104 on each attendee's own client device. In a conventional collaborative environment for sharing multimedia content 104, attendees of an online meeting may be able to view the shared multimedia content 104 provided by the presenter 102 and follow along with the presenter's playback of the multimedia content 104, but the attendees 120, 130 may not be able to interact with or exercise control over the content to control the attendee's playback experience of the multimedia content 104.

In a system according to embodiments, the multimedia content 104 may be provided to the attendees 120, 130 over the networked environment 110, and the multimedia content 104 may be rendered on each attendee's individual client device such that each individual attendee 120, 130 may be able to interact with the multimedia content 104 and control the playback experience of the multimedia content 104 on the attendee's 120 own client device. The system may enable the attendee 120 to control his own multimedia content experience rather than simply following along with the presenter's control of the multimedia content 104. For example, the attendee 120 may be able to control the timing of the multimedia content 104 playback. The attendee 120 may perform play, pause, seek, scan, stop and other similar playback actions on the multimedia content 104 in order to view the content at the attendee's 120 own desire and pace.

When each individual attendee 120 interacts with the multimedia content 104 rendered on his own client device and exercises playback control over the multimedia content 104, the attendee's 120 playback may become un-synchronized with the presenter's 102 playback, such that the presenter's playback of the multimedia content 104 may not be broadcast to the attendee's client device, and the attendee may not view the presenter's playback of the multimedia content. Additionally, the system may enable attendees 120, 130 to view the multimedia content 104 in synchronization with the presenter 102 as the presenter 102 plays and discusses the multimedia content 104 during the online broadcast over the networked environment 110. The presenter 102 may drive the multimedia content 104 playback experience such that the attendees may view the multimedia content as the presenter 102 controls the playback actions. The system may enable the attendee 120 to choose if and when to synchronize with the presenter's playback of the multimedia content 104 according to the attendee's inclination.

In a system according to embodiments, the server 112 may be configured to keep track of the presenter's playback status of the multimedia content while the presenter's playback may be un-synchronized with the attendee's playback for providing the synchronizing and un-synchronizing capabilities. By keeping track of the presenter's playback status of the multimedia content 104, the system may enable the attendee 120 to re-synchronize with the presenter's multimedia content playback if and when the attendee 120 desires. According to example embodiments, when the presenter 102 initially begins playback of the multimedia content 104, the presenter's client device may continuously provide playback state information 106 of the multimedia content 104 to the server 112.

The state information 106 may include the current playback position of the multimedia content 104 on the presenter's client device, and other playback data such as when the presenter plays, seeks, rewinds, forwards, pauses, advances, slows, and stops the multimedia content, as well as other playback information such as whether the playback is full screen, the sound is muted, etc. “When” the presenter performs the playback action may be an actual time of the presenter performing the playback action or a position in the multimedia when the presenter performs the action. A system according to embodiments may keep track of both. When the attendee's playback is synchronized with the presenter's playback, the current state information 106 data may be sent from the server 112 to the attendee's device so that the attendee's multimedia content playback may correspond with the presenter's playback of the multimedia content 104. The state information 106 may include a time code for indicating the location of the multimedia content 104 during the playback of the multimedia content 104, so that the attendee may be enabled to re-synchronize with the presenter's playback of the multimedia content 104 at any time. When the attendee selects to synchronize with the presenter's playback, the server 112 may seek to the appropriate position as indicated by the time code included in the state information 106 data.

In an example scenario, upon initial receipt and viewing of multimedia content 104, the attendee 120 may opt to scan through and preview the multimedia content 104, resulting in un-synchronizing the attendee's playback from the presenter's playback. After independently previewing the multimedia content 104, the attendee 120 may desire to resume viewing in synchronization with the presenter's playback. The attendee 120 may select to re-synchronize with the presenter's playback of the multimedia content 104, and based on the state information 106 provided to the server 112 from the presenter's client device, the server 112 may re-synchronize the attendee's 120 playback with the presenter's 102 playback at the location indicated by the state information.

According to another example scenario, one or more attendees may join a broadcast session later than others. Regardless of when the attendees join the broadcast session, they may start initially in sync with the presenter's view based on the state information received at each client. Subsequently, the late joining attendees may also playback independently from the presenter and/or re-synchronize with the presenter.

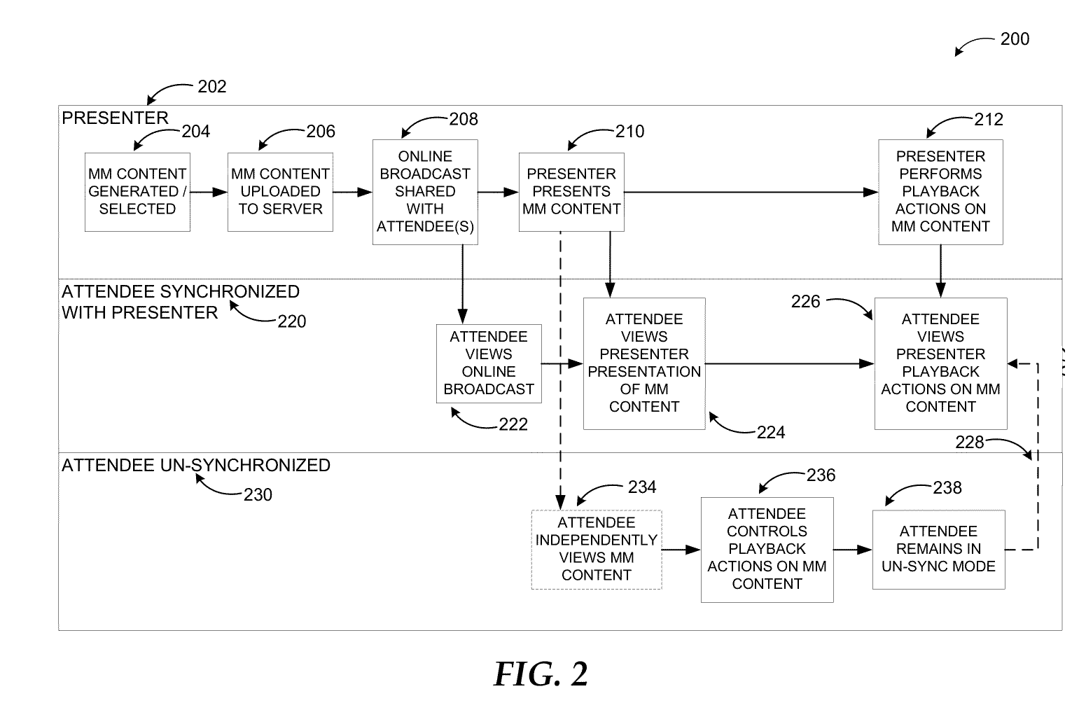

FIG. 2 illustrates an example system for enabling independent control over multimedia content by attendees in a collaborative environment. As demonstrated in diagram 200, a system according to embodiments may enable attendees of an online broadcast to interact with multimedia content and to independently drive the playback experience of the multimedia content on the attendee's own client device. Additionally, the system may enable the presenter to drive the multimedia content playback experience such that the attendees may view the multimedia content as the presenter controls the playback actions.

In an example embodiment, attendees may be enabled to automatically view the multimedia content in synchronization 220 with the presenter 202 as the presenter 202 plays and discusses the multimedia content during the online broadcast or other multimedia sharing method. In an example scenario, the presenter 202 may generate or select from existing multimedia content 204 on the presenter's client device for sharing with one or more attendees of an online broadcast in a collaborative environment. The presenter 202 may upload 206 the multimedia content to a server, and the server may share 208 the online broadcast of the multimedia content with one or more attendees, for example, within a cloud based environment. The attendees may receive the shared broadcast and may view 222 the online broadcast including the multimedia content provided by the presenter 202.

Initially, the attendee's playback of the multimedia content may be automatically synchronized 220 with the presenter's playback of the multimedia content during the online broadcast. While the attendee's playback is synchronized 220 with the presenter's playback, the attendee may simultaneously view the presenter's presentation 224 of the multimedia content as the presenter 202 presents the multimedia content 210. If the attendee takes no actions which may un-synchronize the playback, such as interacting with the multimedia content to control the playback, then as the presenter 202 performs additional playback actions 212 on the multimedia content, the attendee may continuously follow along with and view the presenter's playback actions 226 on the multimedia content. For example, if the presenter 202 shares a slideshow presentation containing an embedded multimedia file over the server, when the presenter plays the multimedia file, the multimedia file may simultaneously play on the synchronized attendee's client device. After the file is finished playing, the presenter may advance to a new slide on the presenter's client device, and the new slide may also be advanced on the synchronized attendee's client device. Similarly, timing, starting, pace, etc. of animations on presentations may also be controlled by each attendee.

In an example embodiment, the presenter's playback and the attendee's playback may be automatically synchronized 220 upon the attendee's receipt and viewing of the multimedia content over the server. The system may enable the attendee to un-synchronize 230 the multimedia content playback at any time by initiating playback control actions over the multimedia content. For example, in the slideshow presentation scenario described above, when the attendee receives the online broadcast for viewing the slideshow, the multimedia content may be rendered on the attendee's client device. The attendee may independently view the multimedia content 234, and may skip to a different slide within the presentation, or as another example, if the shared multimedia content is a video file, the attendee may play the video, scan forward and pause the video. As soon as the attendee performs playback actions 236 over the multimedia content on the attendee's client device, the presenter playback and the attendee's playback may automatically become un-synchronized 230, and the attendee may have full control over the playback of the multimedia content on the attendee's client device independent of the presenter's playback of the multimedia content.

The attendee playback of the multimedia content may remain un-synchronized 238 unless and until the attendee may elect to re-synchronize 228 with the presenter playback. As described above, the attendee may select at any time to re-synchronize 228 with the presenter's playback, and based on state information data provided by the presenter, the server may synchronize the attendee playback with the presenter playback at the appropriate position.

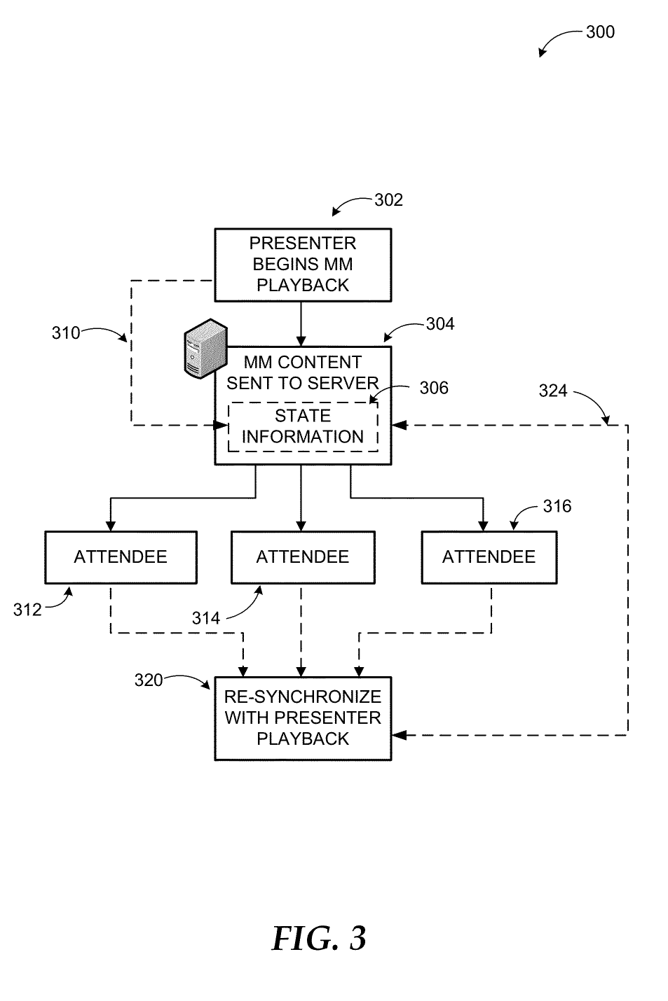

FIG. 3 illustrates an example scenario for enabling independent control over multimedia content by attendees in a collaborative environment according to embodiments. As demonstrated in diagram 300, a presenter in a collaborative environment may initiate playback of multimedia content 302 during an online broadcast over a collaborative server. The multimedia content may be provided to the server 304 by the presenter's device, and the server may broadcast the multimedia content such that the one or more attendees 312, 314, 316 may be able to view the multimedia content on each attendee's own client device. Additionally, the server may continuously monitor the presenter's playback status of the multimedia content based on state information 306 of the position of the presenter's playback provided 310 to the server by the presenter's client device for providing the synchronizing and un-synchronizing capabilities.

In an example embodiment, each attendee 312, 314, 316 may receive an independent broadcast stream of the multimedia content from the server, such that each attendee 312, 314, 316 may have independent playback control over the received multimedia content. While each attendee 312, 314, 316 views the independent broadcast stream of the multimedia content, the attendee may remain synchronized with presenter playback such that the attendee 312 may view the presenter's playback of the multimedia content. Additionally, the attendee may initiate playback control actions over the multimedia content, such as play, pause, scan, and stop actions, which may result in un-synchronizing the attendee's playback of the multimedia content from the presenter's playback of the multimedia content.

In further embodiments, the system may enable the attendee to re-synchronize 320 with the presenter's multimedia content playback if and when the attendee desires. When the attendee 312 elects to re-synchronize 320 with the presenter's playback, the current state information 306 data may be sent from the server to the attendee's client device so that the attendee's multimedia content playback may correspond to the presenter's playback of the multimedia content.

The example systems in FIG. 1 through 3 have been described with specific configurations, applications, and interactions. Embodiments are not limited to systems according to these examples. A system for enabling independent playback control over multimedia content in a collaborative environment may be implemented in configurations employing fewer or additional components and performing other tasks. Furthermore, specific protocols and/or interfaces may be implemented in a similar manner using the principles described herein.

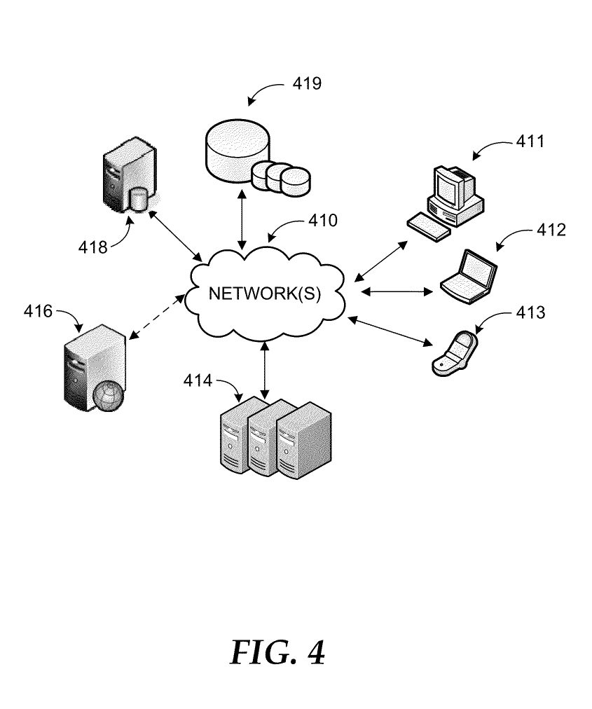

FIG. 4 is an example networked environment, where embodiments may be implemented. A system for enabling independent playback control over multimedia content in a collaborative environment may be implemented via software executed over one or more servers 414 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 414, or on individual server 416. An application executed on one of the servers may facilitate enabling independent playback control over multimedia content in a collaborative environment. The application may retrieve relevant data from data store(s) 419 directly or through database server 418, and provide requested services (e.g. document editing) to the user(s) through client devices 411-413.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform for enabling independent playback control over multimedia content in a collaborative environment. Furthermore, the networked environments discussed in FIG. 4 are for illustration purposes only. Embodiments are not limited to the example applications, modules, or processes.

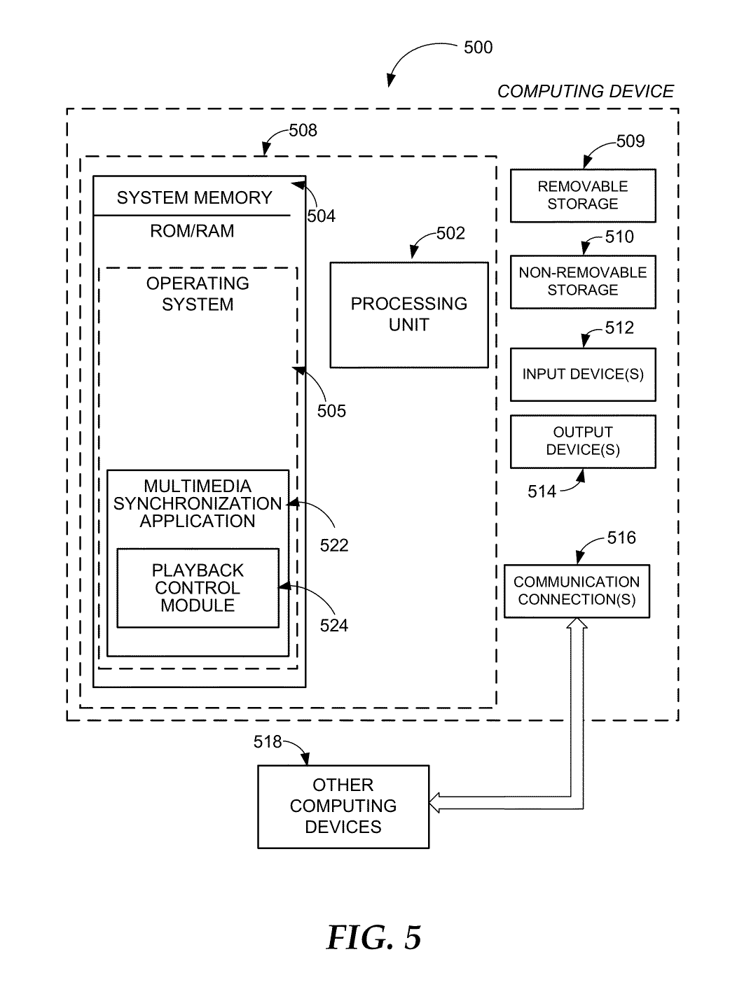

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application for enabling independent playback control over multimedia content in a collaborative environment according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as a multimedia synchronization application 522, and playback control module 524.

Playback control module 524 may enable a computing device 500 to continually detect a collaborative environment for sharing and presenting multimedia content over an online broadcast. Through the playback control module 524, multimedia synchronization application 522 may enable attendees of the online broadcast to receive multimedia content and to independently view, interact with, and perform playback control actions on the multimedia content. The multimedia synchronization application 522 may enable the attendee's playback of the multimedia content to become un-synchronized with the presenter's playback while the attendee exercises playback control over the multimedia content. Additionally, the multimedia synchronization application 522 may enable the attendee's playback of the multimedia content to become re-synchronized with the presenter's playback of the multimedia content upon election by the attendee. Multimedia synchronization application 522 and playback control module 524 may be separate applications or integrated modules of a hosted service. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

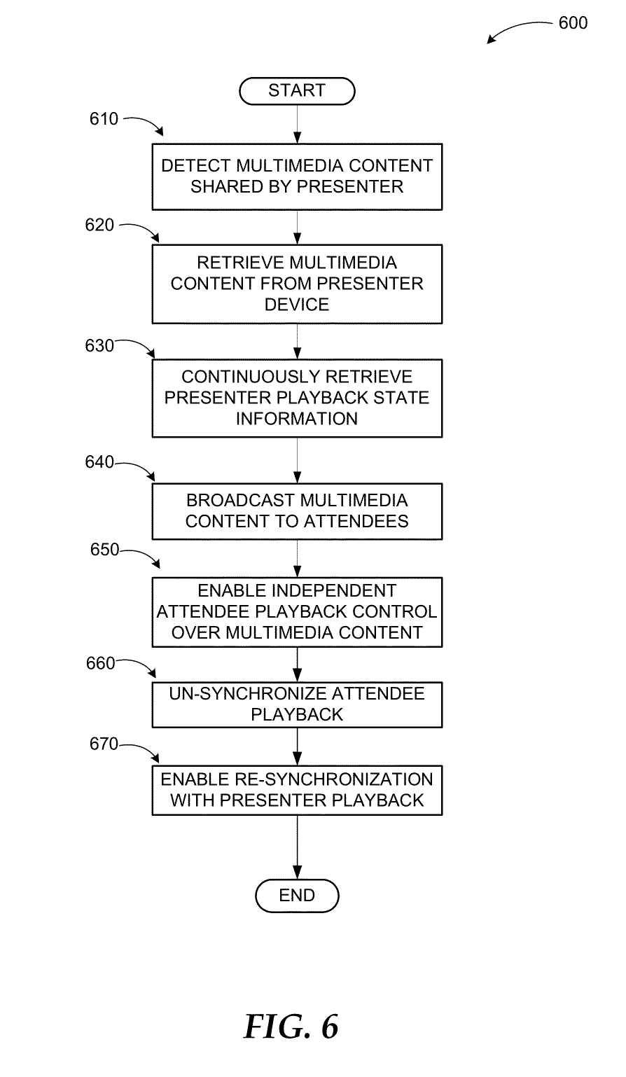

FIG. 6 illustrates a logic flow diagram for process 600 for enabling independent playback control over multimedia content in a collaborative environment according to embodiments. Process 600 may be implemented on a computing device or similar electronic device capable of executing instructions through a processor.

Process 600 begins with operation 610, where a server may detect multimedia content shared by a presenter in a collaborative environment. At operation 620, the presenter may upload the multimedia content, and the server may retrieve the multimedia content for sharing with one or more attendees in an online broadcast or meeting. At operation 630 the server may continuously retrieve presenter playback state information of the multimedia content. The state information may include the current playback position of the multimedia content on the presenter's client device, and other playback data such as when the presenter plays, seeks, pauses, and stops the multimedia content.

At operation 640 the server may broadcast the multimedia content such that the one or more attendees may be able to view the multimedia content on each attendee's own client device. Initially, the attendee's playback of the multimedia content may be automatically synchronized with the presenter's playback of the multimedia content during the online broadcast. While the attendee's playback is synchronized 220 with the presenter's playback, the attendee may simultaneously view the presenter's presentation of the multimedia content as the presenter presents the multimedia content. At operation 650 the system may enable the attendee to control his own multimedia content experience. The multimedia content may be rendered on the attendee's individual client device such that the individual attendee may be able to interact with the multimedia content and control the playback experience of the multimedia content on the attendee's own client device. For example, the attendee may perform play, pause, seek, scan, stop and other similar playback actions on the multimedia content in order to view the content at the attendee's own desire and pace.

Operation 650 may be followed by operation 660 where the presenter's playback and the attendee's playback may be un-synchronized, such that the presenter's playback of the multimedia content may not be broadcast to the attendee's client device and the attendee may not view the presenter's playback of the multimedia content. At operation 670, after independently controlling the multimedia content playback, the attendee may select to re-synchronize with the presenter's playback, and based on the state information provided to the server from the presenter's client device, the server may re-synchronize the presenter's playback and the attendee's playback.

The operations included in process 600 are for illustration purposes. Automatically enabling independent playback control over multimedia content in a collaborative environment may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for sharing multimedia content in an online meeting, the method comprising:
detecting sharing of multimedia content by a presenter;
receiving the multimedia content at a collaborative server;
broadcasting the multimedia content to at least one attendee of the online meeting;
enabling the multimedia content to be rendered on the attendee's client device; and
enabling the attendee to execute control actions over the multimedia content on the attendee's client device.

2. The method of claim 1, wherein the control actions include one or more of: playing, seeking, scanning, pausing, rewinding, forwarding, advancing, slowing and stopping the multimedia content.

3. The method of claim 1, further comprising:
enabling the attendee to control one or more of a timing, a starting, and a pace of an animation embedded in the multimedia content.

4. The method of claim 1, further comprising:
detecting a playback control action by the attendee over the multimedia content; and
automatically un-synchronizing the presenter's playback of the multimedia content with the attendee's playback of the multimedia content on the attendee's client device.

5. The method of claim 1, further comprising continuously retrieving state information of the presenter's playback of the multimedia content on the presenter's client device.

6. The method of claim 5, wherein the state information includes a current playback position of the multimedia content at the presenter's client device, and playback data such as when the presenter plays, seeks, pauses, and stops the multimedia content.

7. The method of claim 1, further comprising:
enabling the attendee to elect to re-synchronize the attendee's playback of the multimedia content with the presenter's playback of the multimedia content; and
re-synchronizing the attendee's playback of the multimedia content with the presenter's playback based on the state information.

8. The method of claim 7, further comprising re-synchronizing the attendee's playback of the multimedia content with the presenter's playback based on a time code included in the state information for indicating a position of the presenter's playback of the multimedia content.

9. The method of claim 1, wherein re-synchronizing the attendee's playback of the multimedia content with the presenter's playback based on the state information further comprises seeking to a position of the attendee's playback of the multimedia content on the attendee's client device corresponding to the position of the presenter's playback of the multimedia content indicated by the time code included in the state information.

10. The method of claim 1, wherein the online meeting includes in addition to enabling multimedia content to be shared exchange of one or more of: e-mail messaging, text messaging, audio conferencing, video conferencing, whiteboard sharing, desktop sharing, and application sharing.

11. The method of claim 1, wherein the multimedia content includes one or more of: audio files, video files, image files, word processing files, spreadsheet files, and presentation files.

12. A server for facilitating sharing multimedia content in an online meeting, the server comprising:
a memory;
a processor coupled to the memory, the processor executing a playback synchronization application, wherein the online meeting application is configured to:
detect sharing of multimedia content by a presenter;
receive the multimedia content from the presenter's client device;
broadcast the multimedia content to at least one attendee of the online meeting;
enable the multimedia content to be rendered on the attendee's client device;
enable the attendee to execute control actions over the multimedia content on the attendee's client device;
detect playback of the multimedia content by the presenter on the presenter's client device; and
automatically synchronize the presenter's playback of the multimedia content with playback by the attendee's of the multimedia content on the attendee's client device.

13. The server of claim 12, wherein the online meeting application is further configured to:
enable the multimedia content to be cached at the attendee's client device.

14. The server of claim 12, wherein the online meeting application is further configured to:
enable the attendee to remain synchronized with the presenter's playback of the multimedia content, such that the attendee is enabled to continuously view the multimedia content as the presenter controls the playback actions.

15. The server of claim 12, wherein the online meeting application is further configured to:
detect a control action by the attendee over the multimedia content, wherein the control action includes one or more of: playing, seeking, scanning, pausing, rewinding, forwarding, advancing, slowing and stopping the multimedia content; and
automatically un-synchronize the attendee's playback of the multimedia content on the attendee's individual client device with the presenter's playback of the multimedia content.

16. The server of claim 12, wherein the online meeting application is further configured to:
continuously retrieve state information of the presenter's playback of the multimedia content on the presenter's client device, wherein the state information includes the current playback position of the multimedia content on the presenter's client device, and playback data including when the presenter plays, seeks, pauses, and stops the multimedia content;
enable the attendee to re-synchronize the attendee's playback of the multimedia content with the presenter's playback of the multimedia content; and
re-synchronize the attendee's playback of the multimedia content with the presenter's playback based on the state information.

17. The server of claim 12, wherein the online meeting application is further configured to:
detect a re-synchronize election by the attendee;
retrieve current state information of the presenter's playback of the multimedia content;
retrieve a time code included in the state information, wherein the time code indicates a position of the presenter's playback of the multimedia content;
seek to a position of the multimedia content on the attendee's client device corresponding to the position of the presenter's playback of the multimedia content indicated by the time code in the state information; and
re-synchronize the attendee's playback of the multimedia content with the presenter's playback of the multimedia content.

18. The server of claim 12, wherein the online meeting includes two or more attendees; and wherein each attendee receives an independent broadcast stream of the multimedia content from the collaborative server in a cloud based environment.

19. A computer-readable memory device with instructions stored thereon for sharing multimedia content in an online meeting in a collaborative environment, the instructions comprising:
detecting sharing of multimedia content by a presenter;
receiving the multimedia content at a collaborative server;
broadcasting the multimedia content to at least one attendee of the online meeting;
enabling the multimedia content to be rendered on the attendee's client device; and
enabling the attendee to execute control actions over the multimedia content on the attendee's client device;
detecting a playback action associated with the multimedia content by the presenter on the presenter's client device;
enabling playback of the multimedia content by the presenter;
automatically synchronizing the presenter's playback of the multimedia content with the attendee's playback of the multimedia content on the attendee's client device;
detecting a control action by the attendee over the multimedia content, wherein the control action includes one or more of: playing, seeking, scanning, pausing, rewinding, forwarding, advancing, slowing and stopping the multimedia content; and
automatically un-synchronizing the presenter's playback of the multimedia content with the attendee's playback of the multimedia content on the attendee's client device.

20. The computer-readable memory device of claim 19, wherein the instructions further comprise:
enabling the multimedia content to be cached at the attendee's client device; and
enabling playback of the multimedia at the attendee's client device independently from the presenter's playback of the multimedia based on the state information broadcast to the attendee.
